(19) United States
(12) Patent Application Publication
(10) Pub. No.: US 2009/0094282 A1
(43) Pub. Date: Apr. 9, 2009

(54) Systems and methods for correlating past epigenetic information with past disability data

(75) Inventors: Edward K.Y. Jung, Bellevue, WA (US); Roderick A. Hyde, Redmond, WA (US); Jordin T. Kare, Seattle, WA (US); Eric C. Leuthardt, St. Louis, MO (US); Dennis J. Rivet, Portsmouth, VA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(73) Assignee: Searete LLC, a limited liability corporation of the State of Delaware

(21) Appl. No.: 12/006,249

(22) Filed: Dec. 31, 2007

Related U.S. Application Data
(63) Continuation-in-part of application No. 11/906,995, filed on Oct. 4, 2007.
Application No. 11/906,995 is a continuation-in-part of application No. 11/974,166, filed on Oct. 11, 2007.
Application No. 11/974,166 is a continuation-in-part of application No. 11/986,967, filed on Nov. 27, 2007.
Application No. 11/986,967 is a continuation-in-part of application No. 11/986,986, filed on Nov. 27, 2007.
Application No. 11/986,986 is a continuation-in-part of application No. 11/986,966, filed on Nov. 27, 2007.
Application No. 11/986,966 is a continuation-in-part of application No. 12/004,098, filed on Dec. 19, 2007.

(51) Int. Cl. G06F 17/30

(52) U.S. Cl. 707/104.1; 707/E17.044

(57) ABSTRACT

A method includes receiving epigenetic information associated with at least a first individual for at least a first epigenetic-information interval of time, receiving disability data associated with at least a first individual for at least a first disability-data interval of time, and/or correlating the epigenetic information associated with at least a first individual for at least a first epigenetic-information interval of time with the disability data associated with at least a first individual for at least a first disability-data interval of time.

A system includes means for receiving epigenetic information associated with at least a first individual for at least a first epigenetic-information interval of time, means for receiving disability data associated with at least a first individual for at least a first disability-data interval of time, and means for correlating the epigenetic information associated with at least a first individual for at least a first epigenetic-information interval of time with the disability data associated with at least a first individual for at least a first disability-data interval of time.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/906,995, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 4, 2007, which is currently co-pending, Or is an application of which a currently co-pending application is entitled to the benefit of the filing date.
For purposes of the USPTO extra-statutory requirements, the present application constitutes a continuation-in-part of U.S. patent application Ser. No. 11/974,166, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 11, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/986,967, entitled SYSTEMS AND METHODS FOR ANONYMIZING PERSONALLY IDENTIFIABLE INFORMATION ASSOCIATED WITH EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed NOVEMBER 27, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/986,986, entitled SYSTEMS AND METHODS FOR TRANSFERRING COMBINED EPIGENETIC INFORMATION AND OTHER INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/986,966, entitled SYSTEMS AND METHODS FOR REINSURANCE UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.
For purposes of the USPTO extra-statutory requirements, the present application constitutes a continuation-in-part of U.S. patent application entitled SYSTEMS AND METHODS FOR CORRELATING EPIGENETIC INFORMATION WITH DISABILITY DATA, naming Roderick A. Hyde, Jordin T. Kare, Eric C. Leuthardt, Dennis J. Rivet, Michael A. Smith; and Lowell L. Wood, Jr. as inventors, filed Dec. 19, 2007, Express Mailing Label Number EM005739045US, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/op/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

A method includes receiving epigenetic information associated with at least a first individual for at least a first epigenetic-information interval of time, receiving disability data associated with at least a first individual for at least a first disability-data interval of time, and/or correlating the epigenetic information associated with at least a first individual for at least a first epigenetic-information interval of time with the disability data associated with at least a first individual for at least a first disability-data interval of time. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A system includes means for receiving epigenetic information associated with at least a first individual for at least a first epigenetic-information interval of time, means for receiving disability data associated with at least a first individual for at least a first disability-data interval of time, and means for correlating the epigenetic information associated with at least a first individual for at least a first epigenetic-information interval of time with the disability data associated with at least a first individual for at least a first disability-data interval of time. In addition to the foregoing, other method aspects are described in the claims, drawings, and text forming a part of the present disclosure.

A system includes circuitry for receiving epigenetic information associated with at least a first individual for at least a first epigenetic-information interval of time, circuitry for receiving disability data associated with at least a first individual for at least a first disability-data interval of time, and circuitry for correlating the epigenetic information associated with at least a first individual for at least a first epigenetic-information interval of time with the disability data associated with at least a first individual for at least a first disability-data interval of time. In addition to the foregoing, other method aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates an exemplary environment in which one or more technologies may be implemented.

FIG. 2 illustrates an operational flow representing example operations related to correlating past epigenetic information associated with at least a first individual with past disability data associated with at least a first individual.

FIG. 3 illustrates an alternative embodiment of the operational flow of FIG. 2.

FIG. 4 illustrates an alternative embodiment of the operational flow of FIG. 2.

FIG. 5 illustrates an alternative embodiment of the operational flow of FIG. 2.

FIG. 6 illustrates an alternative embodiment of the operational flow of FIG. 2.

FIG. 7 illustrates an alternative embodiment of the operational flow of FIG. 2.

FIG. 8 illustrates an alternative embodiment of the operational flow of FIG. 2.

FIG. 9 illustrates an alternative embodiment of the operational flow of FIG. 2.

FIG. 10 illustrates an alternative embodiment of the operational flow of FIG. 2.

FIG. 11 illustrates an alternative embodiment of the operational flow of FIG. 2.

FIG. 12 illustrates an alternative embodiment of the operational flow of FIG. 2.

FIG. 13 illustrates an alternative embodiment of the operational flow of FIG. 2.

FIG. 14 illustrates an alternative embodiment of the operational flow of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

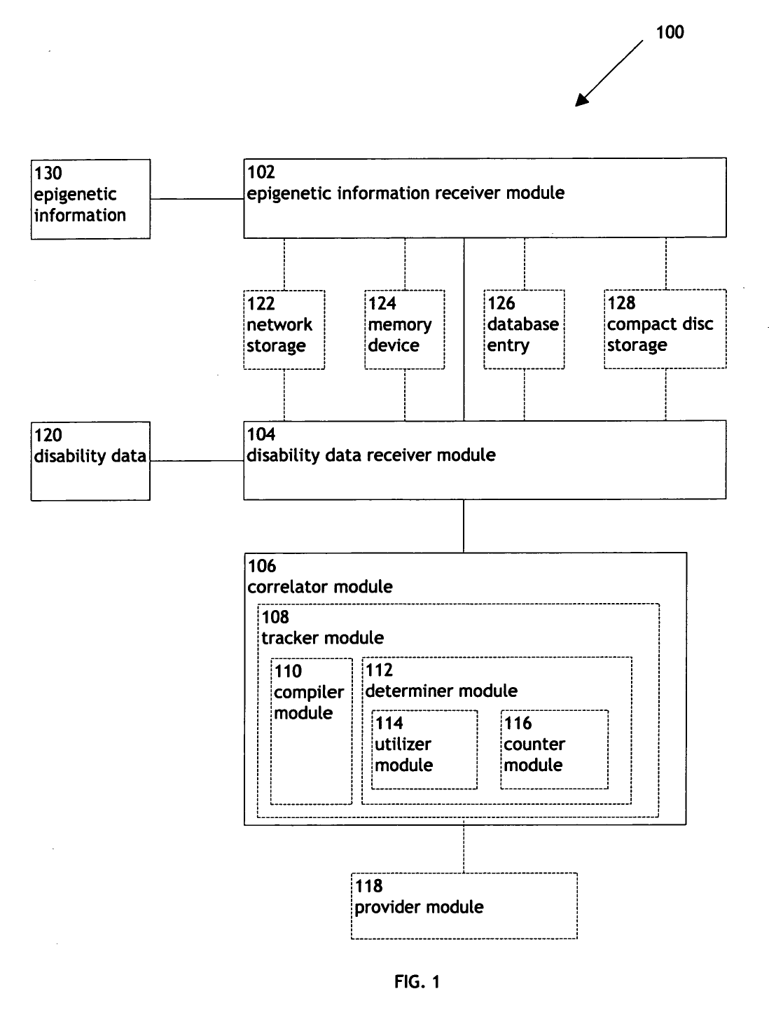

Referring to FIG. 1, a system 100 for correlating epigenetic information associated with at least a first person with disability data associated with at least a second person is illustrated. The system 100 may include epigenetic information receiver module 102, disability data receiver module 104, and/or correlator module 106. The system 100 may further include provider module 118. Epigenetic information receiver module 102 may receive epigenetic information 130 from network storage 122, memory device 124, database entry 126, and/or compact disc storage 128. Disability data receiver module 104 may receive disability data 120 from network storage 122, memory device 124, database entry 126, and/or compact disc storage 128. Correlator module 106 may further include tracker module 108. Tracker module 108 may further include compiler module 110 and/or determiner module 112. Determiner module may further include utilizer module 114 and/or counter module 116. System 100 generally represents instrumentality for correlating past epigenetic information associated with at least a first person with past disability data associated with at least a first person. Correlating past epigenetic information associated with at least a first person with past disability data associated with at least a first person may be accomplished electronically, such as with a set of interconnected electrical components, an integrated circuit, and/or a computer processor.

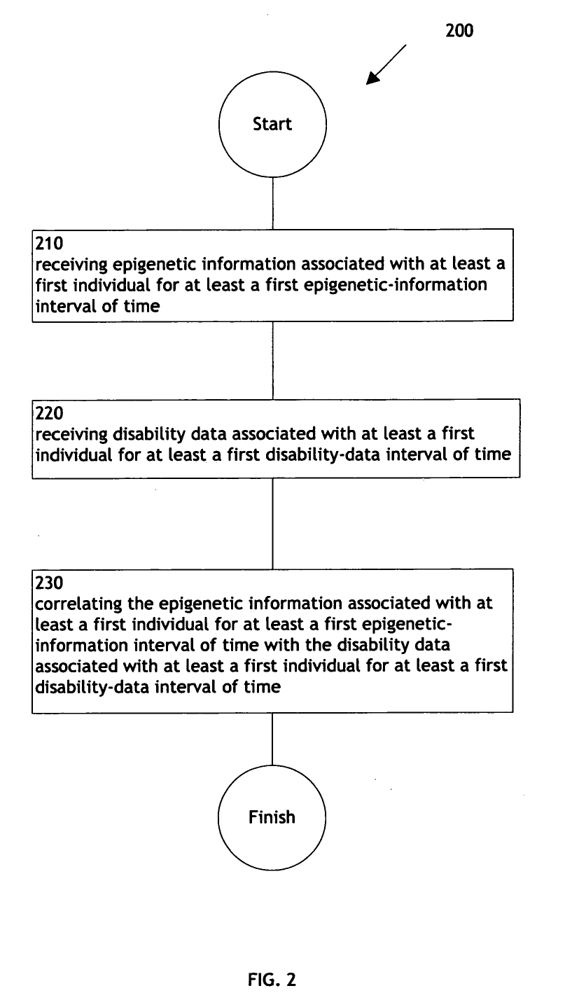

FIG. 2 illustrates an operational flow 200 representing example operations related to receiving epigenetic information associated with at least a first individual for at least a first epigenetic-information interval of time, receiving disability data associated with at least a first individual for at least a first disability-data interval of time, and/or correlating the epigenetic information associated with at least a first individual for at least a first epigenetic-information interval of time with the disability data associated with at least a first individual for at least a first disability-data interval of time. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200 moves to a receiving epigenetic information associated with at least a first individual for at least a first epigenetic-information interval of time operation 210, where epigenetic information associated with at least a first individual for at least a first epigenetic-information interval of time may be received. For example, as shown in FIG. 1, epigenetic information receiver module 102 may receive epigenetic information associated with at least a first individual for at least a first epigenetic-information interval of time. In one specific example, epigenetic information receiver module 102 receives from network storage 122 for a first individual named John Smith epigenetic information for a period of time spanning from Jan. 1, 1980 to the death of John Smith on Jan. 1, 2000. Some explanation regarding epigenetic information 118 may be found in sources such as Bird, Perceptions of Epigenetics, NATURE 477, 396-398 (2007); Grewal and Elgin, Transcription and RNA Interference in the Formation of Heterochromatin, NATURE 447: 399-406 (2007); and Callinan and Feinberg, The Emerging Science of Epigenomics, HUMAN MOLECULAR GENETICS 15, R95-R101 (2006), each of which are incorporated herein by reference. Epigenetic information may include, for example, information regarding DNA methylation, histone states or modifications, transcriptional activity, RNAi, protein binding or other molecular states. Further, epigenetic information may include information regarding inflammation-mediated cytosine damage products. See, e.g., Valinluck and Sowers, Inflammation-Mediated Cytosine Damage: A Mechanistic Link Between Inflammation and the Epigenetic Alterations in Human Cancers, CANCER RESEARCH 67: 5583-5586 (2007), which is incorporated herein by reference. In some instances, epigenetic information receiver module 102 may include a computer processor. Proper nouns and/or names used herein are meant to be exemplary only.

Then, in a receiving disability data associated with at least a first individual for at least a first disability-data interval of time operation 220, disability data associated with at least a first individual for at least a first disability-data interval of time may be received. For example, as shown in FIG. 1, disability data receiver module 104 may receive disability data associated with at least a first individual for at least a first disability-data interval of time. In one specific instance and continuing with the example above, disability data receiver module 104 receives from memory device 124 disability data for an individual named John Smith for a period of time spanning from Jan. 1, 1980 to the death of John Smith on Jan. 1, 2000. In some instances, disability data receiver module 104 may include a computer processor.

Then, in a correlating the epigenetic information associated with at least a first individual for at least a first epigenetic-information interval of time with the disability data associated with at least a first individual for at least a first disability-data interval of time operation 230, the epigenetic information associated with at least a first individual for at least a first epigenetic-information interval of time and the disability data associated with at least a first individual for at least a first disability-data interval of time may be correlated. For example, as shown in FIG. 1, correlator module 106 may correlate the epigenetic information associated with at least a first individual for at least a first epigenetic-information interval of time and the disability data associated with at least a first individual for at least a first disability-data interval of time. In a specific instance and continuing with the example above, correlator module 106 correlates the epigenetic information received for John Smith pertaining to a period of time spanning from Jan. 1, 1980 to the death of John Smith on Jan. 1, 2000 with the disability data received for John Smith pertaining to a period of time spanning from Jan. 1, 1980 to the death of John Smith on Jan. 1, 2000. In some instances, correlator module 106 may include a computer processor.

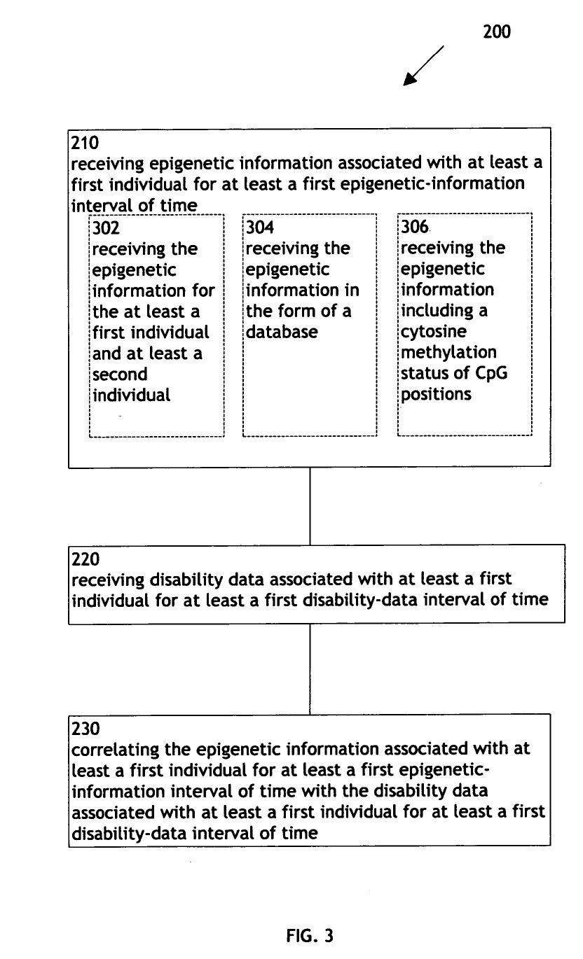

FIG. 3 illustrates alternative embodiments of the example operational flow 200 of FIG. 2. FIG. 3 illustrates example embodiments where the receiving epigenetic information associated with at least a first individual for at least a first epigenetic-information interval of time operation 210 may include at least one additional operation. Additional operations may include an operation 302, an operation 304, and/or an operation 306.

At the operation 302, the epigenetic information for the at least a first individual and at least a second individual may be received. For example, as shown in FIG. 1, epigenetic information receiver module 102 may receive epigenetic information for the at least a first individual and at least a second individual. In one specific instance, epigenetic information receiver module 102 receives epigenetic information regarding a certain DNA methylation status from database entry 126 for a first individual named Robert Green and for a second individual named William Green. The at least a first individual and the at least a second individual may or may not have a blood relationship and/or a familial relationship. In some instances, epigenetic information receiver module 102 may include a computer processor.

At the operation 304, the epigenetic information in the form of a database may be received. For example, as shown in FIG. 1, epigenetic information receiver module 102 may receive the epigenetic information in the form of a database. In one specific instance, epigenetic information receiver module 102 receives from compact disc storage 128 the epigenetic information in the form of a database. A database may include a collection of data organized for convenient access. The database may include information digitally stored in a memory device 124, as at least a portion of at least one database entry 126, in compact disc storage 128, and/or in network storage 122. In some instances, the database may include information stored non-digitally such as at least a portion of a book, a paper file, and/or a non-computerized index and/or catalog. Non-computerized information may be received by epigenetic information receiver module 102 by scanning or manually entering the information into a digital format. In some instances, epigenetic information receiver module 102 may include a computer processor.

At the operation 306, the epigenetic information including a cytosine methylation status of CpG positions may be received. For example, as shown in FIG. 1, epigenetic information receiver module 102 may receive the epigenetic information including a cytosine methylation status of CpG positions. In one specific instance, epigenetic information receiver module 102 receives from network storage 122 the epigenetic information including a cytosine methylation status of CpG positions. DNA methylation and cytosine methylation status of CpG positions for an individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference. In some instances, epigenetic information receiver module 102 may include a computer processor.

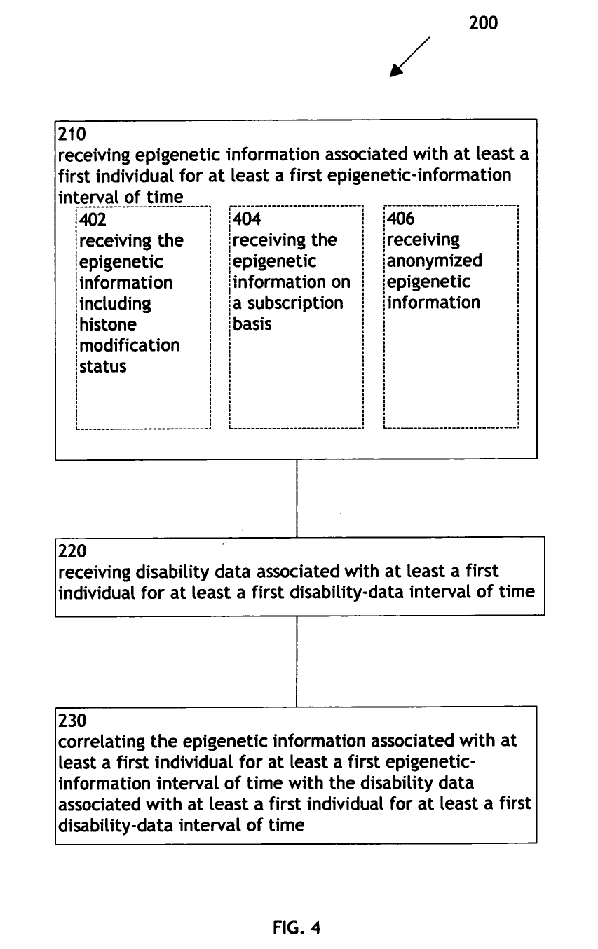

FIG. 4 illustrates alternative embodiments of the example operational flow 200 of FIG. 2. FIG. 4 illustrates example embodiments where the receiving epigenetic information associated with at least a first individual for at least a first epigenetic-information interval of time operation 210 may include at least one additional operation. Additional operations may include an operation 402, an operation 404, and/or an operation 406.

At the operation 402, the epigenetic information including histone modification status may be received. For example, as shown in FIG. 1, epigenetic information receiver module 102 may receive epigenetic information including histone modification status. In one specific example, epigenetic information receiver module 102 receives from memory device 124 epigenetic information including a histone modification status for a group of individuals. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference. In some instances, epigenetic information receiver module 102 may include a computer processor.

At the operation 404, the epigenetic information on a subscription basis may be received. For example, as shown in FIG. 1, epigenetic information receiver module 102 may receive the epigenetic information on a subscription basis. In a specific example, epigenetic information receiver module 102 may receive from database entry 126 the epigenetic information on a subscription basis for a period of one year. A subscription may include an agreement to receive and/or be given access to the epigenetic information. The subscription may include access to epigenetic information in a digital form and/or a physical form of information, such as paper printouts. In some instances, epigenetic information receiver module 102 may include a computer processor.

At the operation 406, anonymized epigenetic information may be received. For example, as shown in FIG. 1, epigenetic information receiver module 102 may receive anonymized epigenetic information. In one instance, epigenetic information receiver module 102 receives from compact disc storage 128 anonymized epigenetic information. Anonymized epigenetic information may be received for more than one individual, such as a group of two hundred individuals. Anonymized epigenetic information may be anonymized in different degrees and by different methods. Different degrees of anonymization may include full anonymization and/or partial anonymization, such as in the case of pseudonym utilization. Methods for anonymizing epigenetic information may include the use of cell suppression and/or utilizing anonymization algorithms. In some instances, epigenetic information receiver module 102 may include a computer processor.

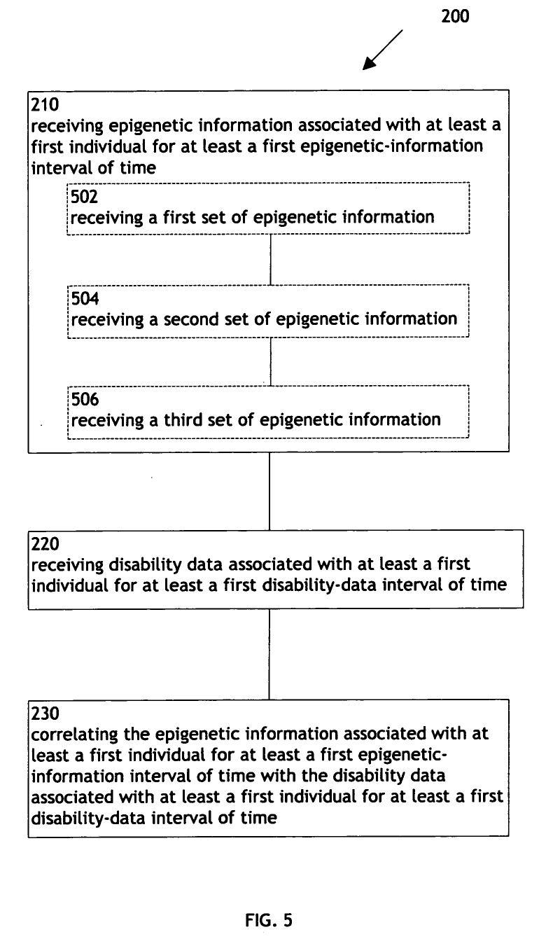

FIG. 5 illustrates alternative embodiments of the example operational flow 200 of FIG. 2. FIG. 5 illustrates example embodiments where the receiving epigenetic information associated with at least a first individual for at least a first epigenetic-information interval of time operation 210 may include at least one additional operation. Additional operations may include an operation 502, an operation 504, and/or an operation 506.

At the operation 502, a first set of epigenetic information may be received. For example, as shown in FIG. 1, epigenetic information receiver module 102 may receive a first set of epigenetic information. In one specific instance, epigenetic information receiver module 102 receives from network storage 122 a first set of epigenetic information regarding a specific histone structure modification. A set of information may include a set amount of information and both terms may be used interchangeably herein. Further, a set of information may include batch, finite, and/or discrete amounts information. Additionally, epigenetic information may be received for more than one individual. Then, at the operation 504, a second set of epigenetic information may be received. For example, as shown in FIG. 1, epigenetic information receiver module 102 may receive a second set of epigenetic information. In one specific instance, epigenetic information receiver module 102 receives from network storage 122 a second set of epigenetic information regarding a specific histone structure modification. Further, at the operation 506, a third set of epigenetic information may be received. For example, as shown in FIG. 1, epigenetic information receiver module 102 may receive a third set of epigenetic information. In one specific instance, epigenetic information receiver module 102 receives from network storage 122 a third set of epigenetic information regarding a specific histone structure modification. Additional sets of information may be received by epigenetic information receiver module 102 as batches or finite sets beyond the first, second, and third set of epigenetic information. In some instances, epigenetic information receiver module 102 may include a computer processor.

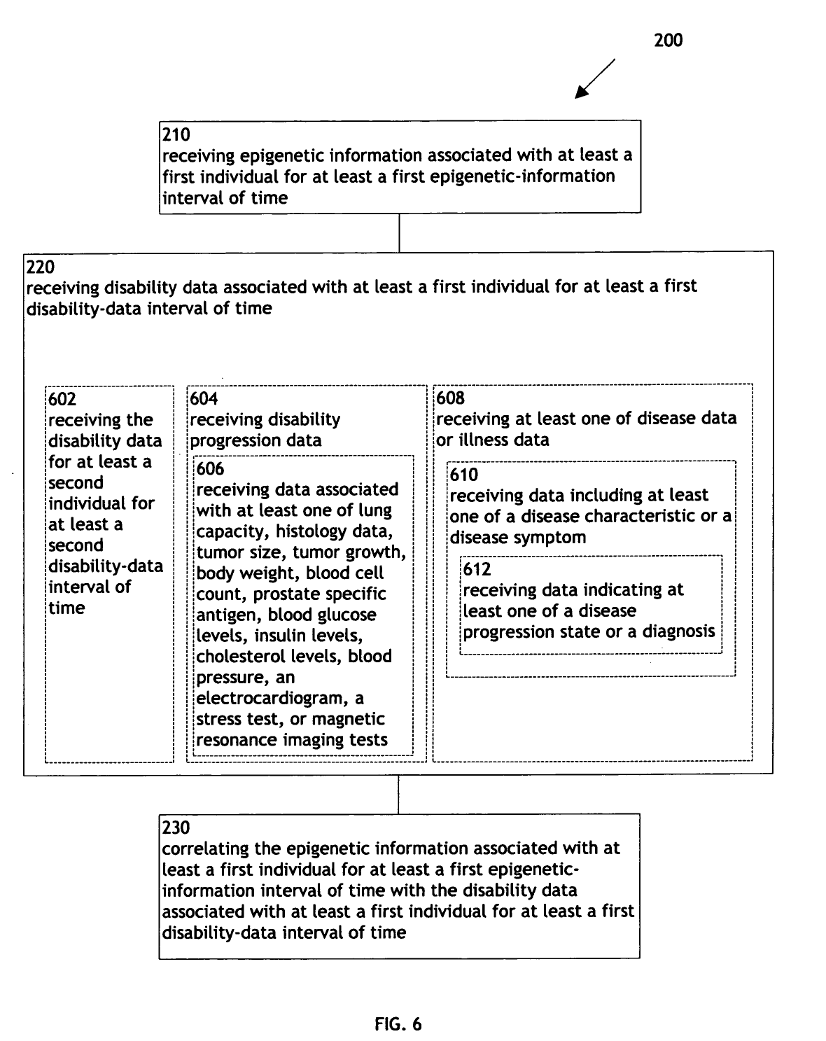

FIG. 6 illustrates alternative embodiments of the example operational flow 200 of FIG. 2. FIG. 6 illustrates example embodiments where the receiving disability data associated with at least a first individual for at least a first disability-data interval of time operation 220 may include at least one additional operation. Additional operations may include an operation 602, an operation 604, an operation 606, an operation 608, an operation 610, and/or an operation 612.

At the operation 602, the disability data for at least a second individual for at least a first disability-data interval of time may be received. For example, as shown in FIG. 1, disability data receiver module 104 may receive the disability data for at least a second individual for at least a first disability-data interval of time. In one specific instance, disability data receiver module 104 receives from memory device 124 disability data for a first individual named Ron Wilson and a second individual named Robert Jones for a period of time from Jan. 5, 2000 until the deaths of Ron Wilson and Robert Jones. In some instances, disability data receiver module 104 may include a computer processor.

At the operation 604, disability progression data may be received. For example, as shown in FIG. 1, disability data receiver module 104 may receive disability progression data. In one specific instance, disability data receiver module 104 receives from database entry 126 disability progression data indicating the progression of lung disease for a group of people in a specific geographical area. Disability progression data may include data indicating the progression of a disability, illness, and/or disease. In some instances, disability data receiver module 104 may include a computer processor. Further, at the operation 606, data associated with at least one of lung capacity, histology data, tumor size, tumor growth, body weight, blood cell count, prostate specific antigen, blood glucose levels, insulin levels, cholesterol levels, blood pressure, an electrocardiogram, a stress test, or magnetic resonance imaging tests may be received. For example, as shown in FIG. 1, disability data receiver module 104 may receive data associated with at least one of lung capacity, histology data, tumor size, tumor growth, body weight, blood cell count, prostate specific antigen, blood glucose levels, insulin levels, cholesterol levels, blood pressure, an electrocardiogram, a stress test, or magnetic resonance imaging tests. In one specific instance, disability data receiver module 104 receives from compact disc storage 128 data including the amount of tumor growth, the size of a tumor, and lung capacity for a person having lung cancer. In another specific instance, disability data receiver module 104 receives from compact disc storage 128 data including an insulin level and a blood glucose level for a person having diabetes. In another specific instance, disability data receiver module 104 receives from compact disc storage 128 data including an electrocardiogram for a person having coronary heart disease. In some instances, disability data receiver module 104 may include a computer processor.

At the operation 608, at least one of disease data or illness data may be received. For example, as shown in FIG. 1, disability data receiver module 104 may receive at least one of disease data or illness data. In one specific instance, disability data receiver module 104 receives from database entry 126 disease data indicating the occurrence of lung disease for a specific geographical area and illness data indicating the occurrence of pneumonia for the same geographical area. In some instances, disability data receiver module 104 may include a computer processor. Further, at the operation 610, data including at least one of a disease characteristic or a disease symptom may be received. For example, as shown in FIG. 1, disability data receiver module 104 may receive data including at least one of a disease characteristic or a disease symptom. In one specific instance, disability data receiver module 104 receives from compact disc storage 128 data including a disease characteristic, such as the abnormal proliferation of white blood cells, indicating a likelihood of leukemia. Disease characteristics and/or disease symptoms may include indications and/or other evidence of the occurrence of illness and/or disease. Disease characteristics and/or disease symptoms may further include other medical signs indicating the nature of a disease and/or illness. A few other examples of disease characteristics and/or disease symptoms may include chest pains indicating heart attack, skin discoloration and or abnormal skin growths indicating a likelihood of skin cancer, and/or jaundice indicating a likelihood of liver disease. Further, at the operation 612, data indicating at least one of a disease progression state or a diagnosis may be received. For example, as shown in FIG. 1, disability data receiver module 104 may receive data indicating at least one of a disease progression state or a diagnosis. In one specific instance, disability data receiver module 104 receives from database entry 126 data indicating a disease progression state for lung cancer. A disease progression state may include an indication of the stage of development for a disease and may include an estimated time left until death for at least one individual. A diagnosis may include the identification of a disease from signs, symptoms, laboratory tests, radiological results and/or physical findings. In some instances, disability data receiver module 104 may include a computer processor.

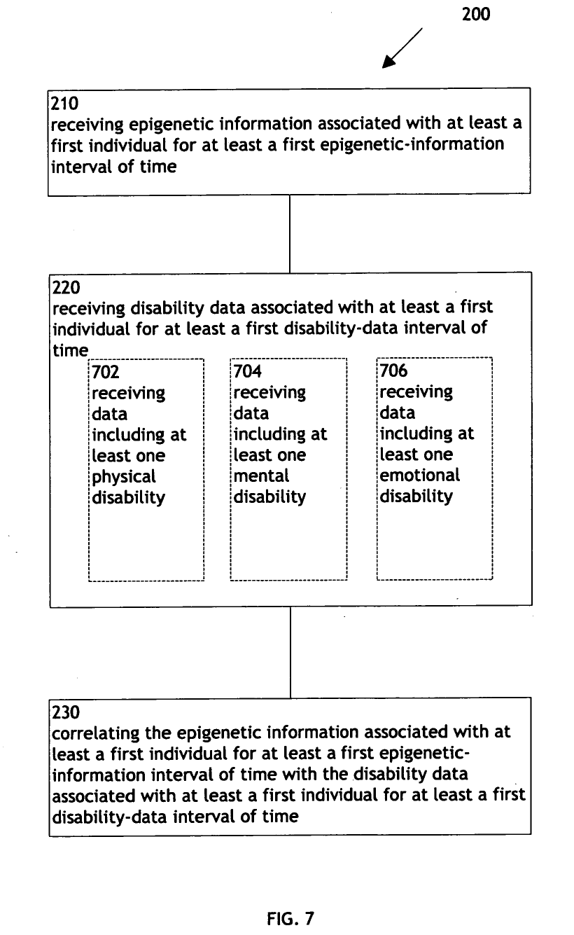

FIG. 7 illustrates alternative embodiments of the example operational flow 200 of FIG. 2. FIG. 7 illustrates example embodiments where the receiving disability data associated with at least a first individual for at least a first disability-data interval of time operation 220 may include at least one additional operation. Additional operations may include an operation 702, an operation 704, and/or an operation 706.

At the operation 702, data including at least one physical disability may be received. For example, as shown in FIG. 1, disability data receiver module 104 may receive data including at least one physical disability. In one specific instance, disability data receiver module 104 receives from memory device 124 data including a physical disability. A physical disability may include physical impairment, sensory impairment, chronic disease, as well as other impairment to body structure and/or impairment to body function. In some instances, disability data receiver module 104 may include a computer processor.

At the operation 704, data including at least one mental disability may be received. For example, as shown in FIG. 1, disability data receiver module 104 may receive data including at least one mental disability. In one specific instance, disability data receiver module 104 receives from network storage 122 data including a mental disability. A mental disability may include a mental impairment that limits one or more major life activities of the person with the mental impairment. Examples of a mental disability and/or a mental impairment may include depression, mania, bipolar disorder, mental retardation, learning difficulty, mood disorders, anxiety disorders, psychotic disorders, eating disorders, personality disorders, as well as many other disabilities. In some instances, disability data receiver module 104 may include a computer processor.

At the operation 706, data including at least one emotional disability may be received. For example, as shown in FIG. 1, disability data receiver module 104 may receive data including at least one emotional disability. In one instance, disability data receiver module 104 receives from network storage 122 data including an emotional disability. An emotional disability may include a condition that, over a certain time period and to a marked degree, consistently interferes with a learning ability. An emotional disability may often occur in children and/or adolescents. In some instances, disability data receiver module 104 may include a computer processor.

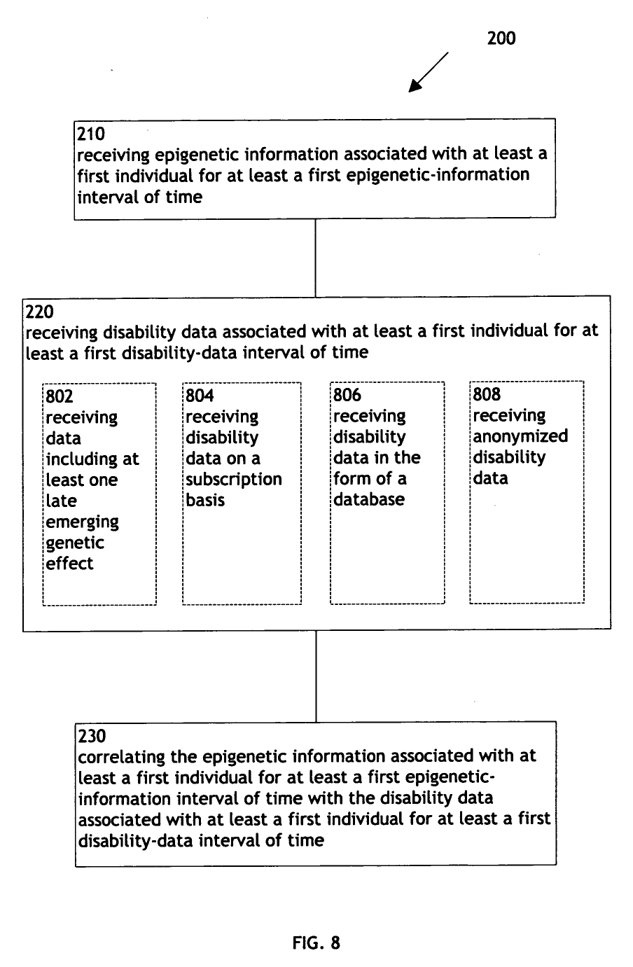

FIG. 8 illustrates alternative embodiments of the example operational flow 200 of FIG. 2. FIG. 8 illustrates example embodiments where the receiving disability data associated with at least a first individual for at least a first disability-data interval of time operation 220 may include at least one additional operation. Additional operations may include an operation 802, an operation 804, an operation 806, and/or an operation 808.

At the operation 802, data including at least one late emerging genetic effect may be received. For example, as shown in FIG. 1, disability data receiver module 104 may receive data including at least one late emerging genetic effect. In one specific instance, disability data receiver module 104 receives data including a late emerging genetic effect including a disposition for Parkinson's disease. A late emerging effect may include effects, occurring after a certain period of time not having the effect, resulting from genetic, epigenetic, environmental, and/or other factors. The effects may include disease, illness, side reactions, physical disability, emotional disability, mental disability, and/or other types of impairment. In some instances, disability data receiver module 104 may include a computer processor.

At the operation 804, disability data may be received on a subscription basis. For example, as shown in FIG. 1, disability data receiver module 104 may receive disability data on a subscription basis. In one specific instance, disability data receiver module 104 receives disability data on a subscription basis. A subscription may include an agreement to receive and/or be given access to the disability data. The subscription may include access to disability data in a digital form and/or a physical form of information, such as paper printouts. In some instances, disability data receiver module 104 may include a computer processor.

At the operation 806, disability data may be received in the form of a database. For example, as shown in FIG. 1, disability data receiver module 104 may receive disability data in the form of a database. In one specific example, disability data receiver module 104 receives disability data relating to a mental disability in the form of a database. A database may include a collection of data organized for convenient access. The database may include information digitally stored in a memory device 124, as at least a portion of at least one database entry 126, in compact disc storage 128, and/or in network storage 122. In some instances, the database may include information stored non-digitally such as at least a portion of a book, a paper file, and/or a non-computerized index and/or catalog. Non-computerized information may be received by epigenetic information receiver module 102 by scanning or manually entering the information into a digital format. In some instances, disability data receiver module 104 may include a computer processor.

At the operation 808, anonymized disability data may be received. For example, as shown in FIG. 1, disability data receiver module 104 may receive anonymized disability data. In a specific example, disability data receiver module 104 receives disability data indicating an emotional disability anonymized by the use of cell suppression. Anonymized epigenetic information may be anonymized in different degrees and by different methods. Different degrees of anonymization may include full anonymization and/or partial anonymization, such as in the case of pseudonym utilization. Methods for anonymizing epigenetic information may include the use of cell suppression and/or utilizing anonymization algorithms. In some instances, disability data receiver module 104 may include a computer processor.

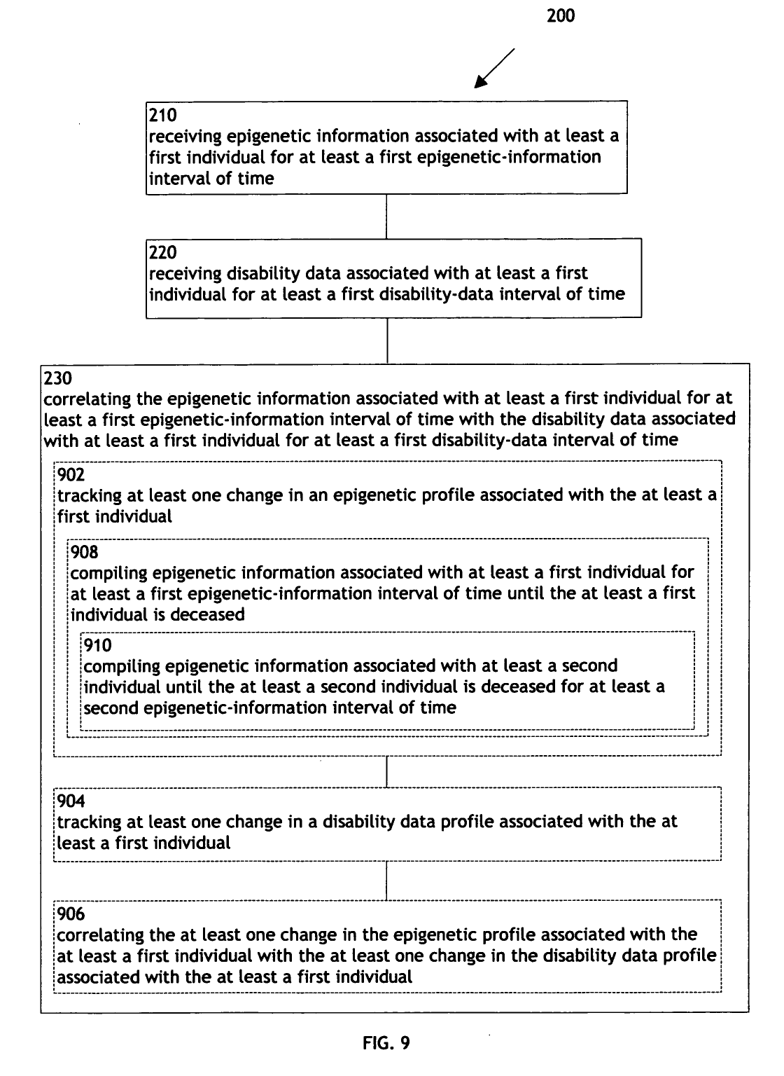

FIG. 9 illustrates alternative embodiments of the example operational flow 200 of FIG. 2. FIG. 9 illustrates example embodiments where the correlating the epigenetic information associated with at least a first individual for at least a first epigenetic-information interval of time with the disability data associated with at least a first individual for at least a first disability-data interval of time operation 230 may include at least one additional operation. Additional operations may include an operation 902, an operation 904, an operation 906, an operation 908, and/or an operation 910.

At the operation 902, at least one change in an epigenetic profile associated with the at least a first individual may be tracked. For example, as shown in FIG. 1, tracker module 108 may track at least one change in an epigenetic profile associated with the at least a first individual. In a specific instance, tracker module 108 tracks changes in an epigenetic profile associated with a first individual named Roger Wheeler. Tracking at least one change in an epigenetic profile may include logging epigenetic information and/or characteristics at multiple points in time for at least one individual. For example, tracking at least one change in an epigenetic profile may include tracking a modification to a histone structure and/or methylation of a DNA structure. In some instances, a tracker module 108 may include a computer processor. Then, at the operation 904, at least one change in a disability data profile associated with the at least a first individual may be tracked. For example, as shown in FIG. 1, tracker module 108 may track at least one change in a disability data profile associated with the at least a first individual. In a specific example and continuing with the example above, tracker module 108 tracks at least one change in a disability data profile associated with a first individual named Roger Wheeler. Tracking at least one change in a disability data profile may include logging disability data and/or characteristics at multiple points in time for at least one individual. In some instances, a tracker module 108 may include a computer processor. Then, at the operation 906, the at least one change in the epigenetic profile associated with the at least a first individual may be correlated with the at least one change in the disability data profile associated with the at least a first individual. For example, as shown in FIG. 1, correlator module 106 may correlate the at least one change in the epigenetic profile associated with the at least a first individual with the at least one change in the disability data profile associated with the at least a first individual. In one instance and continuing with the example above, correlator module 106 correlates the changes in an epigenetic profile for a first individual named Roger Wheeler with disability data profile associated with Roger White. In some instances, correlator module 106 may include a computer processor. Further, at the operation 908, epigenetic information associated with at least a first individual may be compiled for at least a first epigenetic-information interval of time until the at least a first individual is deceased. For example, as shown in FIG. 1, compiler module 110 may compile epigenetic information associated with at least a first individual for at least a first epigenetic-information interval of time until the at least a first individual is deceased. In one instance, compiler module 110 compiles epigenetic information associated with a first individual named Terry Johnson indicating a specific histone structure modification for a period of time spanning from Jun. 1, 1990 until Jul. 1, 2004 when Terry Johnson is deceased. In some instances, compiler module 110 may include a computer processor. Further, at the operation 910, epigenetic information associated with at least a second individual may be compiled for at least a second epigenetic-information interval of time until the at least a second individual is deceased. For example, as shown in FIG. 1, compiler module 110 may compile epigenetic information associated with at least a second individual for at least a second epigenetic-information interval of until the at least a second individual is deceased. In one specific instance, compiler module 110 compiles epigenetic information associated with at a second individual named George Anderson for a time spanning from Apr. 1, 1997, until George Anderson dies on Apr. 1, 2007. In some instances, compiler module 110 may include a computer processor.

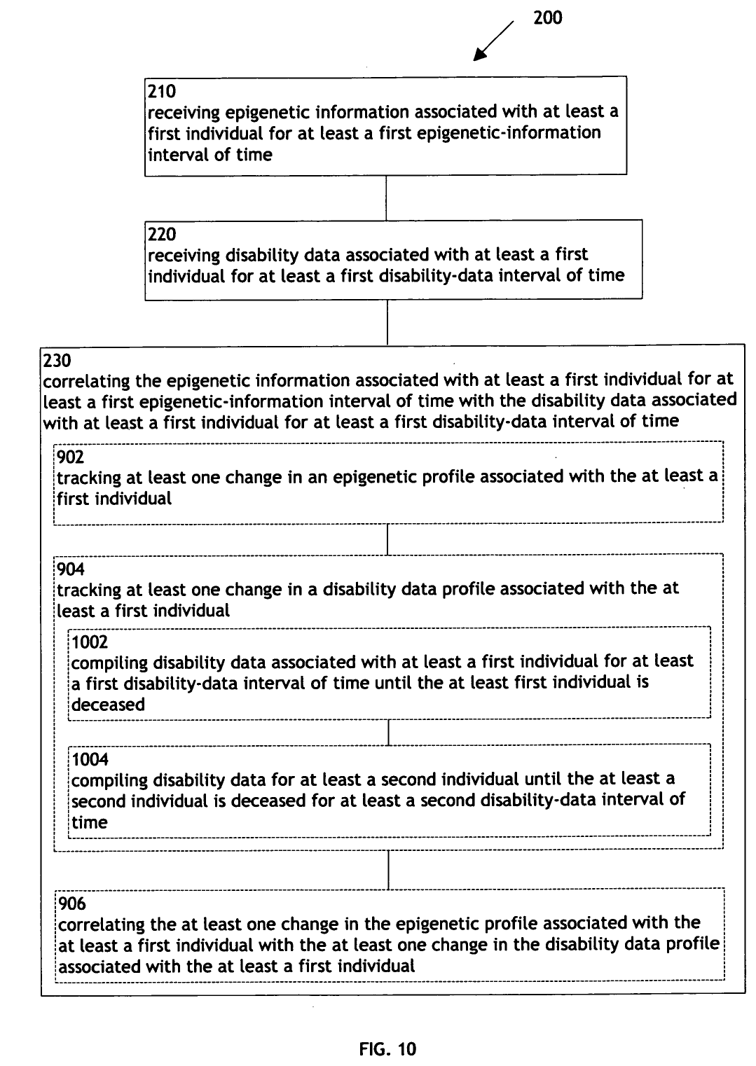

FIG. 10 illustrates alternative embodiments of the example operational flow 200 of FIG. 2. FIG. 10 illustrates example embodiments where the correlating the epigenetic information associated with at least a first individual for at least a first disability-data interval of time with the disability data associated with at least a first individual for at least a first disability-data interval of time operation 230 may include at least one additional operation. Additional operations may include an operation 1002, and/or an operation 1004. Further, at the operation 1002, disability data associated with at least a first individual may be compiled for at least a first disability-data interval of time until the at least first individual is deceased. For example, as shown in FIG. 1, compiler module 110 may compile disability data associated with at least a first individual for at least a first disability-data interval of time until the at least first individual is deceased. In one specific instance, compiler module 110 compiles disability data including mental disability associated with at least a first individual named Tom Smith for a time period from May 1, 1995 until Tom Smith dies on May 1, 2005. In some instances, compiler module 110 may include a computer processor. Further, at the operation 1004, disability data may be compiled for at least a second individual until the at least a second individual is deceased for at least a second disability-data interval of time. For example, as shown in FIG. 1, compiler module 110 may compile disability data for at least a second individual until the at least a second individual is deceased for at least a second disability-data interval of time. In one specific instance and continuing with the example above, compiler module 110 compiles disability data for a first individual named Tom Smith and a second individual named John Smith from Jan. 1, 1998 until John Smith dies on Jan. 26, 2006. In some instances, compiler module 110 may include a computer processor.

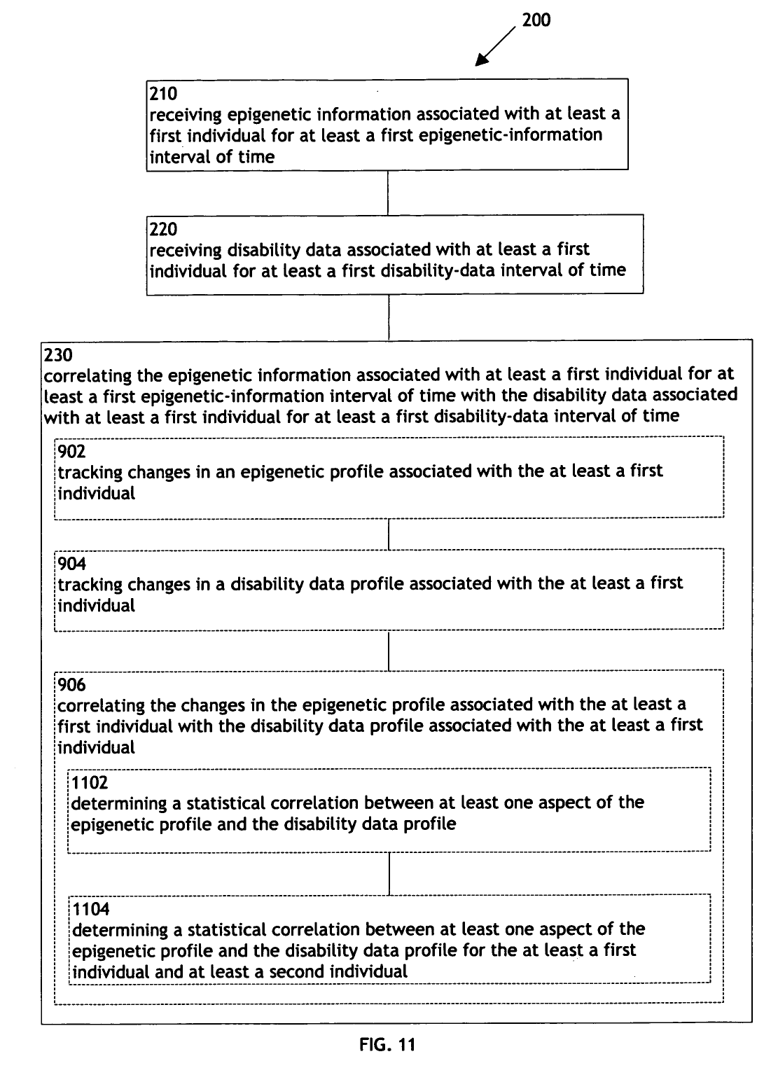

FIG. 11 illustrates alternative embodiments of the example operational flow 200 of FIG. 2. FIG. 11 illustrates example embodiments where the correlating the epigenetic information associated with at least a first individual for at least a first disability-data interval of time with the disability data associated with at least a first individual for at least a first disability-data interval of time operation 230 may include at least one additional operation. Additional operations may include an operation 1102, and/or an operation 1104. Further, at the operation 1102, statistical correlation between at least one aspect of the epigenetic profile and the disability data profile may be determined. For example, as shown in FIG. 1, determiner module 112 may determine a statistical correlation between at least one aspect of the epigenetic profile and the disability data profile. In a specific instance, determiner module 112 determines a statistical correlation between an aspect of the epigenetic profile and an aspect in a disability data profile. A statistical correlation may indicate the strength and direction of a linear relationship between two variables, such as epigenetic information data and/or disability data. In some instances, a determiner module 112 may include a computer processor. Further, at the operation 1104, a statistical correlation between at least one aspect of the epigenetic profile and the disability data profile for the at least a first individual and at least a second individual may be determined. For example, as shown in FIG. 1, determiner module 112 may determine a statistical correlation between at least one aspect of the epigenetic profile and the disability data profile for the at least a first individual and at least a second individual. In a specific instance, determiner module 112 determines a statistical correlation between at least one aspect of the epigenetic profile including a change in histone structure and a disability data profile for a first individual named Bill Norton and a second individual named Fred Jones. In some instances, determiner module 112 may include a computer processor.

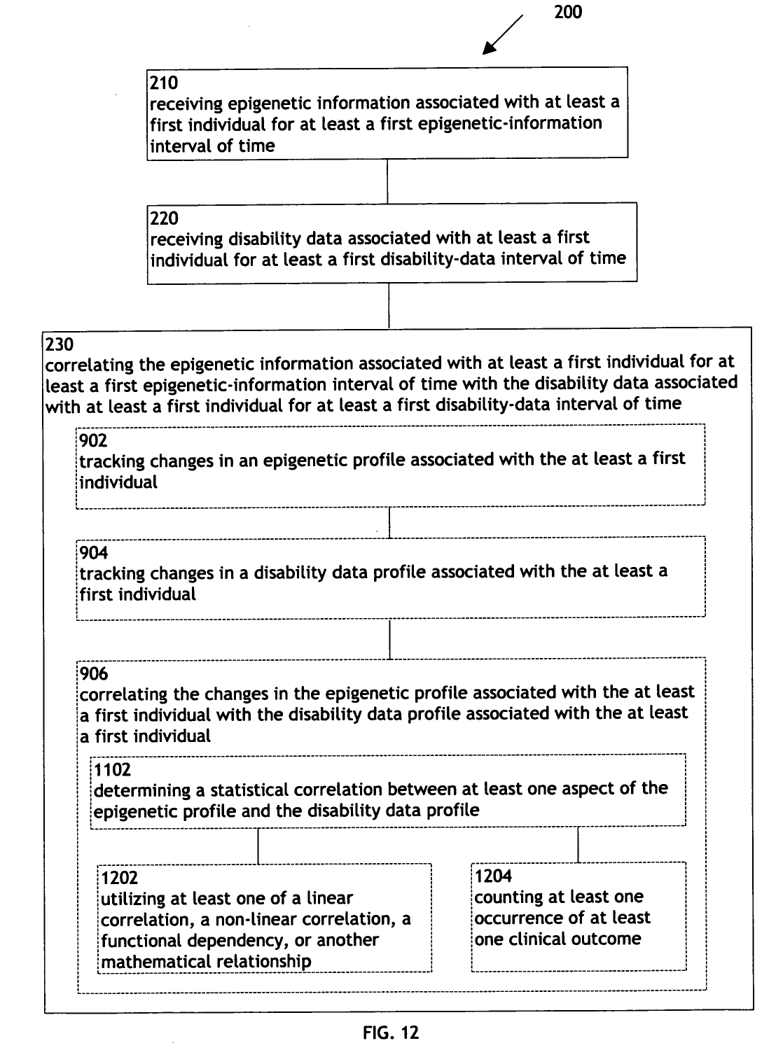

FIG. 12 illustrates alternative embodiments of the example operational flow 200 of FIG. 2. FIG. 12 illustrates example embodiments where the correlating the epigenetic information associated with at least a first individual for at least a first epigenetic-information interval of time with the disability data associated with at least a first individual for at least a first epigenetic-information interval of time operation 230 may include at least one additional operation. Additional operations may include an operation 1202, and/or an operation 1204. Further, at the operation 1202, at least one of a linear correlation, a non-linear correlation, a functional dependency, or another mathematical relationship may be utilized. For example, as shown in FIG. 1, utilizer module 114 may utilize at least one of a linear correlation, a non-linear correlation, a functional dependency, or another mathematical relationship. In one example, utilizer module 114 utilizes a linear correlation. A linear correlation may include a relationship between variables where the changes in one variable are proportional to changes in the other variable. A non-linear correlation may include a relationship between variables where the changes in one variable are not proportional to changes in the other variable. A functional dependency may exist when one variable is fully determined by another variable. In some instances, utilizer module 114 may include a computer processor. Further, at the operation 1204, at least one occurrence of at least one clinical outcome may be counted. For example, as shown in FIG. 1, counter module 116 may count at least one occurrence of at least one clinical outcome. In a specific instance, counter module 116 counts the occurrences of a clinical outcome including admittance to a hospital and/or a gene mutation. Counting an occurrence of at least one clinical outcome may include counting a single or multiple occurrences of an outcome, such as, for example, a genomic imprinting, a gene mutation, and/or a certain phenotype. In some instances, counter module 116 may include a computer processor.

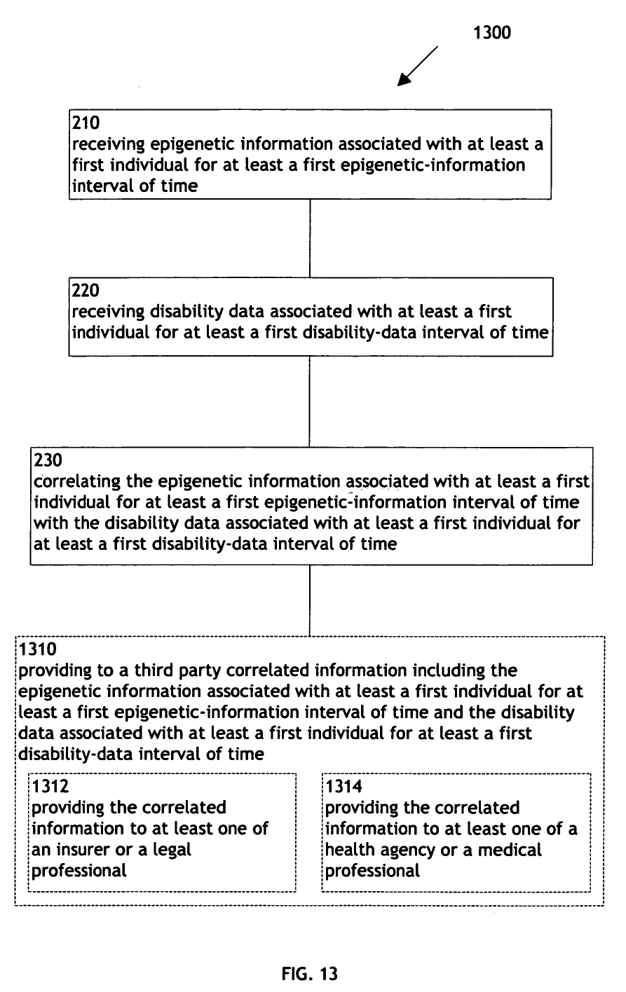

FIG. 13 illustrates an operational flow 1300 representing example operations related to providing to a third party correlated information including the epigenetic information associated with at least a first individual for at least a first epigenetic-information interval of time and the disability data associated with at least a first individual for at least a first disability-data interval of time. FIG. 13 illustrates an example embodiment where the example operational flow 200 of FIG. 2 may include at least one additional operation. Additional operations may include an operation 1310, an operation 1312, and/or an operation 1314.

After a start operation, a receiving epigenetic information associated with at least a first individual for at least a first epigenetic-information interval of time operation 210, a receiving disability data associated with at least a first individual for at least a first disability-data interval of time operation 220, and a correlating the epigenetic information associated with at least a first individual for at least a first epigenetic-information interval of time with the disability data associated with at least a first individual for at least a first disability-data interval of time operation 230, the operational flow 1300 moves to a providing to a third party correlated information including the epigenetic information associated with at least a first individual for at least a first epigenetic-information interval of time and the disability data associated with at least a first individual for at least a first disability-data interval of time operation 1310, where correlated information including the epigenetic information associated with at least a first individual for at least a first epigenetic-information interval of time and the disability data associated with at least a first individual for at least a first disability-data interval of time may be provided to a third party. For example, as shown in FIG. 1, provider module 118 may provide correlated information including the epigenetic information associated with at least a first individual for at least a first epigenetic-information interval of time and the disability data associated with at least a first individual for at least a first disability-data interval of time to a third party. In a specific instance, provider module 118 provides correlated information including epigenetic information associated with a first group of individuals living within a five mile radius of a nuclear reactor from a period of time starting Jan. 1, 1985 and ending Jan. 1, 2000 and disability data associated with the same first group of individuals for the same period of time to a third party including a university. In some instances, provider module 118 may include a computer processor.

At the operation 1312, the correlated information may be provided to at least one of an insurer or a legal professional. For example, as shown in FIG. 1, provider module 118 may supply the correlated information to at least one of an insurer or a legal professional. In one specific instance, provider module 118 supplies the correlated information to an insurer. In another specific instance, provider module 118 supplies the correlated information to a legal professional. An insurer may include a company or an entity that issues a contract for insurance, including health insurance, life insurance, disability insurance, and/or other types of insurance. A legal professional may include an attorney, a paralegal, a law firm, an in-house counsel, a contractor or other entity hired by a legal professional, and/or other entities dealing with the practice or enforcing the law. In some instances, provider module 118 may include a computer processor.

At the operation 1314, the correlated information may be provided to at least one of a health agency or a medical professional. For example, as shown in FIG. 1, provider module 118 may provide the correlated information to at least one of a health agency or a medical professional. In a specific instance, provider module 118 provides the correlated information a health agency. A health agency may include any governmental unit, business, and/or other entity that relates to health. In another specific instance, provider module 118 provides the correlated information a medical professional. A medical professional may include a physician, a nurse, a pharmacist, a physical therapist, a hospital administrator and/or administration staff, an entity hired/employed by a medical professional, and/or other entities dealing with practicing and/or providing medical care. In some instances, provider module 118 may include a computer processor.

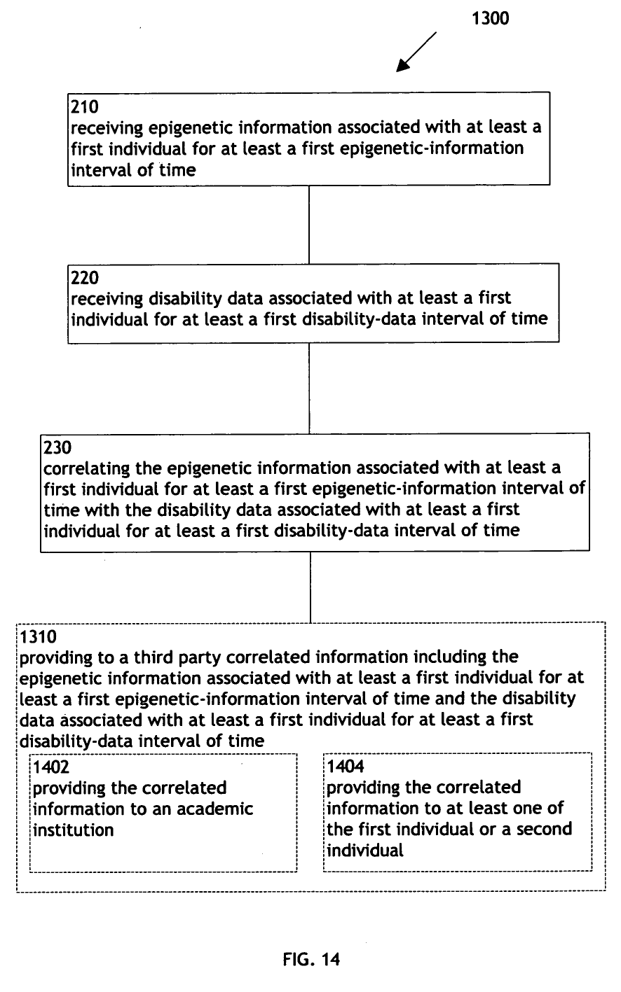

FIG. 14 illustrates alternative embodiments of the example operational flow 1300 of FIG. 13. FIG. 14 illustrates example embodiments where the providing to a third party correlated information including the epigenetic information associated with at least a first individual for at least a first epigenetic-information interval of time and the disability data associated with at least a first individual for at least a first disability-data interval of time operation 1310 may include at least one additional operation. Additional operations may include an operation 1402, and/or an operation 1404.

At the operation 1402, the correlated information may be provided to an academic institution. For example, as shown in FIG. 1, provider module 118 may provide the correlated information to an academic institution. In one example, provider module 118 provides the correlated information to a research university. An academic institution may include a public and/or private educational institution, which may grant academic degrees. In some instances, provider module 118 may include a computer processor.

At the operation 1404, the correlated information may be provided to at least one of the first individual or a second individual. For example, as shown in FIG. 1, provider module 118 may provide the correlated information to at least one of the first individual or a second individual. In a specific instance, provider module 118 provides the correlated information to a first individual named John Gates and a second individual named Frank Jones. The first individual and the second individual may or may not have a blood relationship and/or a familial relationship. In some instances, provider module 118 may include a computer processor.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method comprising:
receiving epigenetic information associated with at least a first individual for at least a first epigenetic-information interval of time;
receiving disability data associated with at least a first individual for at least a first disability-data interval of time; and
correlating the epigenetic information associated with at least a first individual for at least a first epigenetic-information interval of time with the disability data associated with at least a first individual for at least a first disability-data interval of time.

2-36. (canceled)

37. A system, comprising:
means for receiving epigenetic information associated with at least a first individual for at least a first epigenetic-information interval of time;
means for receiving disability data associated with at least a first individual for at least a first disability-data interval of time; and
means for correlating the epigenetic information associated with at least a first individual for at least a first epigenetic-information interval of time with the disability data associated with at least a first individual for at least a first disability-data interval of time.

38. The system of claim 37, wherein means for receiving epigenetic information associated with at least a first individual for at least a first epigenetic-information interval of time comprises:
means for receiving the epigenetic information for the at least a first individual and at least a second individual.

39. The system of claim 37, wherein means for receiving epigenetic information associated with at least a first individual for at least a first epigenetic-information interval of time comprises:
means for receiving the epigenetic information in the form of a database.

40. The system of claim 37, wherein means for receiving epigenetic information associated with at least a first individual for at least a first epigenetic-information interval of time comprises:
means for receiving the epigenetic information including a cytosine methylation status of CpG positions.

41. The system of claim 37, wherein means for receiving epigenetic information associated with at least a first individual for at least a first epigenetic-information interval of time comprises:
means for receiving the epigenetic information including histone modification status.

42. The system of claim 37, wherein means for receiving epigenetic information associated with at least a first individual for at least a first epigenetic-information interval of time comprises:
means for receiving the epigenetic information on a subscription basis.

43. The system of claim 37, wherein means for receiving epigenetic information associated with at least a first individual for at least a first epigenetic-information interval of time comprises:
means for receiving anonymized epigenetic information.

44. The system of claim 37, wherein means for receiving epigenetic information associated with at least a first individual for at least a first epigenetic-information interval of time comprises:
means for receiving a first set of epigenetic information; and
means for receiving a second set of epigenetic information.

45. The system of claim 44, further comprising:
means for receiving a third set of epigenetic information.

46. The system of claim 37, wherein means for receiving disability data associated with at least a first individual for at least a first disability-data interval of time comprises:
means for receiving the disability data for at least a second individual for at least a second disability-data interval of time.

47. The system of claim 37, wherein means for receiving disability data associated with at least a first individual for at least a first disability-data interval of time comprises:
means for receiving disability data progression.

48. The computer-implemented method of claim 47, wherein means for receiving disability data progression comprises:
receiving data associated with at least one of lung capacity, histology data, tumor size, tumor growth, body weight, blood cell count, prostate specific antigen, blood glucose levels, insulin levels, cholesterol levels, blood pressure, an electrocardiogram, a stress test, or magnetic resonance imaging tests.

49. The system of claim 37, wherein means for receiving disability data associated with at least a first individual for at least a first disability-data interval of time comprises:
means for receiving at least one of disease data or illness data.

50. The system of claim 49, wherein means for receiving at least one of disease data or illness data comprises:
means for receiving data including at least one of a disease characteristic or a disease symptom.

51. The system of claim 50, wherein means for receiving data including at least one of a disease characteristic or a disease symptom comprises:
means for receiving data indicating at least one of a disease progression state or a diagnosis.

52. The system of claim 37, wherein means for receiving disability data associated with at least a first individual for at least a first disability-data interval of time comprises:
means for receiving data including at least one physical disability.

53. The system of claim 37, wherein means for receiving disability data associated with at least a first individual for at least a first disability-data interval of time comprises:
means for receiving data including at least one mental disability.

54. The system of claim 37, wherein means for receiving disability data associated with at least a first individual for at least a first disability-data interval of time comprises:
means for receiving data including at least one emotional disability.

55. The system of claim 37, wherein means for receiving disability data associated with at least a first individual for at least a first disability-data interval of time comprises:
means for receiving data including at least one late emerging genetic effect.

56. The system of claim 37, wherein means for receiving disability data associated with at least a first individual for at least a first disability-data interval of time comprises:
means for receiving disability data on a subscription basis.

57. The system of claim 37, wherein means for receiving disability data associated with at least a first individual for at least a first disability-data interval of time comprises:
means for receiving disability data in the form of a database.

58. The system of claim 37, wherein means for receiving disability data associated with at least a first individual for at least a first disability-data interval of time comprises:
means for receiving anonymized disability data.

59. The system of claim 37, wherein means for correlating the epigenetic information associated with at least a first individual for at least a first epigenetic-information interval of time with the disability data associated with at least a first individual for at least a first disability-data interval of time comprises:
means for tracking at least one change in an epigenetic profile associated with the at least a first individual;
means for tracking at least one change in a disability data profile associated with the at least a first individual; and
means for correlating the at least one change in the epigenetic profile associated with the at least a first individual with the at least one change in the disability data profile associated with the at least a first individual.

60. The system of claim 59, wherein means for tracking at least one change in an epigenetic profile associated with the at least a first individual comprises:
means for compiling epigenetic information associated with at least a first individual for at least a first epigenetic-information interval of time until the at least a first individual is deceased.

61. The system of claim 60, wherein means for compiling epigenetic information associated with at least a first individual for at least a first epigenetic-information interval of time until the at least a first individual is deceased comprises:
means for compiling epigenetic information associated with at least a second individual until the at least a second individual is deceased for at least a second epigenetic-information interval of time.

62. The system of claim 59, wherein means for tracking at least one change in a disability data profile associated with the at least a first individual comprises:
means for compiling disability data associated with at least a first individual for at least a first disability-data interval of time until the at least first individual is deceased.

63. The system of claim 62, wherein means for compiling disability data associated with at least a first individual for at least a first disability-data interval of time until the at least first individual is deceased comprises:
means for compiling disability data for at least a second individual until the at least a second individual is deceased for at least a second disability-data interval of time.

64. The system of claim 59, wherein means for correlating the at least one change in the epigenetic profile associated with the at least a first individual with the at least one change in the disability data profile associated with the at least a first individual comprises:
means for determining a statistical correlation between at least one aspect of the epigenetic profile and the disability data profile.

65. The system of claim 64, wherein means for determining a statistical correlation between at least one aspect of the epigenetic profile and the disability data profile comprises:
means for determining a statistical correlation between at least one aspect of the epigenetic profile and the disability data profile for the at least a first individual and at least a second individual.

66. The system of claim 64, wherein means for determining a statistical correlation between at least one aspect of the epigenetic profile and the disability data profile comprises:
means for utilizing at least one of a linear correlation, a non-linear correlation, a functional dependency, or another mathematical relationship.

67. The system of claim 64, wherein means for determining a statistical correlation between at least one aspect of the epigenetic profile and the disability data profile comprises:
means for counting at least one occurrence of at least one clinical outcome.

68. The system of claim 37, further comprising:
means for providing to a third party correlated information including the epigenetic information associated with at least a first individual for at least a first epigenetic-information interval of time and the disability data associated with at least a first individual for at least a first disability-data interval of time.

69. The system of claim 68, wherein means for providing to a third party correlated information including the epigenetic information associated with at least a first individual for at least a first epigenetic-information interval of time and the disability data associated with at least a first individual for at least a first disability-data interval of time comprises:
means for providing the correlated information to at least one of an insurer or a legal professional.

70. The system of claim 68, wherein means for providing to a third party correlated information including the epigenetic information associated with at least a first individual for at least a first epigenetic-information interval of time and the disability data associated with at least a first individual for at least a first disability-data interval of time comprises:
means for providing the correlated information to at least one of a health agency or a medical professional.

71. The system of claim 68, wherein means for providing to a third party correlated information including the epigenetic information associated with at least a first individual for at least a first epigenetic-information interval of time and the disability data associated with at least a first individual for at least a first disability-data interval of time comprises:
means for providing the correlated information to an academic institution.

72. The system of claim 68, wherein means for providing to a third party correlated information including the epigenetic information associated with at least a first individual for at least a first epigenetic-information interval of time and the disability data associated with at least a first individual for at least a first disability-data interval of time comprises:
means for providing the correlated information to at least one of the first individual or a second individual.

73. A system, comprising:
circuitry for receiving epigenetic information associated with at least a first individual for at least a first epigenetic-information interval of time;
